(19) United States
(12) Patent Application Publication
(10) Pub. No.: US 2024/0346412 A1
(43) Pub. Date: Oct. 17, 2024

(54) Real-Time, Context-Aware Resource Delivery for Enterprise Applications

(71) Applicant: Microsoft Technology Licensing, LLC, Redmond, WA (US)

(72) Inventors: Choo Yei CHONG, Redmond, WA (US); Matthew ONTELL, Glen Allen, VA (US); Sakshi GURABA, San Jose, CA (US)

(21) Appl. No.: 18/298,478

(22) Filed: Apr. 11, 2023

(51) Int. Cl. G06Q 10/0631

(52) U.S. Cl. CPC G06Q 10/06312; G06Q 10/063114

(57) ABSTRACT

A method for delivering relevant resources during the execution of an enterprise application is implemented via a computing system and includes executing the enterprise application on a remote computing system operated by an enterprise user, causing the surfacing of a user interface (UI) on the remote computing system's display, determining enterprise user attributes based on enterprise-level data, and responsive to user input including an interaction with the enterprise application, automatically detecting productive state attributes corresponding to a current productive state of the enterprise user with respect to the enterprise application. The method also includes automatically detecting when the current productive state includes a productive value that is below a threshold productive value, automatically determining resource(s) to increase the productive value to above the threshold productive value by applying a propensity model to the enterprise user attributes and the productive state attributes, and providing the resource(s) via the UI.

### BACKGROUND

The present disclosure relates to the utilization of applications for enterprise-related tasks. In particular, the present disclosure relates to techniques for delivering relevant resources in real-time and in a context-aware manner during the execution of enterprise applications by enterprise users.

### SUMMARY

The following presents a simplified summary in order to provide a basic understanding of some aspects described herein. This summary is not an extensive overview of the claimed subject matter. This summary is not intended to identify key or critical elements of the claimed subject matter nor delineate the scope of the claimed subject matter. This summary's sole purpose is to present some concepts of the claimed subject matter in a simplified form as a prelude to the more detailed description that is presented later.

In an embodiment described herein, a method for delivering relevant resources during the execution of an enterprise application by an enterprise user is described. The method is implemented via a computing system including a processor. The method includes executing, via a network, an enterprise application on a remote computing system operated by an enterprise user associated with an enterprise and causing the surfacing of a user interface on a display of the remote computing system during the execution of the enterprise application. The method also includes determining enterprise user attributes of the enterprise user based on enterprise-level data corresponding to the enterprise user and the enterprise and, responsive to user input including an interaction with the enterprise application via the surfaced user interface, automatically detecting productive state attributes corresponding to a current productive state of the enterprise user with respect to the enterprise application. The method also includes automatically detecting when the current productive state of the enterprise user includes a productive value that is below a threshold productive value. The method further includes automatically determining a resource to increase the productive value of the current productive state of the enterprise user to above the threshold productive value by applying a propensity model to the enterprise user attributes and the productive state attributes, as well as providing the resource to the enterprise user via the surfaced user interface.

In another embodiment, a computer-readable storage medium is described. The computer-readable storage medium includes computer-executable instructions that, when executed by a processor, cause the processor to execute an enterprise application on a computing system operated by an enterprise user associated with an enterprise and to cause the surfacing of a user interface on a display of the computing system during the execution of the enterprise application. The computer-readable storage medium also includes computer-executable instructions that, when executed by the processor, cause the processor to determine enterprise user attributes of the enterprise user based on enterprise-level data corresponding to the enterprise user and the enterprise and, responsive to user input including an interaction with the enterprise application via the surfaced user interface, to automatically detect productive state attributes corresponding to a current productive state of the enterprise user with respect to the enterprise application. The computer-readable storage medium further includes computer-executable instructions that, when executed by the processor, cause the processor to automatically detect when the current productive state of the enterprise user includes a productive value that is below a threshold productive value, to automatically determine a resource to increase the productive value of the current productive state of the enterprise user to above the threshold productive value by applying a propensity model to the enterprise user attributes and the productive state attributes, and then to provide the resource to the enterprise user via the surfaced user interface.

In another embodiment, an application service provider server is described. The application service provider server includes a processor and a memory, where the memory includes an enterprise application that is utilized by an enterprise as well as a property graph including enterprise-level data corresponding to the enterprise and corresponding enterprise users. The application service provider server also includes a communication connection for connecting a remote computing system to the application service provider server via a network, where the remote computing system is operated by an enterprise user associated with the enterprise, as well as a computer-readable storage medium operatively coupled to the processor. The computer-readable storage medium includes computer-executable instructions that, when executed by the processor, cause the processor to: execute, via the network, the enterprise application on the remote computing system; cause surfacing of a user interface on a display of the remote computing system during the execution of the enterprise application; extract enterprise-level data corresponding to the enterprise user and the enterprise from the property graph; determine enterprise user attributes of the enterprise user based on the enterprise-level data; responsive to user input including an interaction with the enterprise application via the surfaced user interface, automatically detect productive state attributes corresponding to a current productive state of the enterprise user with respect to the enterprise application; automatically detect when the current productive state of the enterprise user includes a productive value that is below a threshold productive value; automatically determine a resource to increase the productive value of the current productive state of the enterprise user to above the threshold productive value by applying a propensity model to the enterprise user attributes and the productive state attributes; and provide the resource via the surfaced user interface.

The following description and the annexed drawings set forth in detail certain illustrative aspects of the claimed subject matter. These aspects are indicative, however, of a few of the various ways in which the principles of the innovation may be employed and the claimed subject matter is intended to include all such aspects and their equivalents. Other advantages and novel features of the claimed subject matter will become apparent from the following detailed description of the innovation when considered in conjunction with the drawings.

### BRIEF DESCRIPTION OF THE DRAWINGS

The following detailed description may be better understood by referencing the accompanying drawings, which contain specific examples of numerous features of the disclosed subject matter.

FIG. 1 is a simplified schematic view of Microsoft® Graph;

FIG. 2 is a process flow diagram of a method for delivering relevant resources in real-time and in a context-aware manner during the execution of an enterprise application by an enterprise user according to embodiments described herein;

FIG. 3 is a block diagram of an exemplary computing system for implementing the techniques described herein;

FIG. 4 is a block diagram of an exemplary network environment for implementing the techniques described herein; and

FIG. 5 is a block diagram of an exemplary computer-readable storage medium for implementing the techniques described herein.

### DETAILED DESCRIPTION

The utilization of technology products, such as, in particular, enterprise applications, to perform enterprise-related tasks can be complicated. As a result, various online support communities, partner ecosystems, and in-application tools have been developed to assist enterprise users who are struggling to fully utilize enterprise applications to meet their enterprise's goals. Unfortunately, however, conventional solutions for assisting enterprise users with such enterprise applications are largely inefficient and time-consuming. Specifically, according to such conventional solutions, when an enterprise user desires assistance with performing one or more tasks with respect to an enterprise application, the enterprise user is typically forced to open a separate browser and then independently search for assistance from an online community or partner or, in some cases, to locate a suitable in-application tool that is capable of providing assistance and then specifically engage with such in-application tool.

Therefore, the present techniques address these and other issues by providing for real-time, context-aware resource delivery for enterprise applications, where such resources are delivered within the context of the enterprise applications (i.e., without requiring enterprise users to separately search for such resources). In particular, the present techniques may be broken down into at least three aspects: (1) determining the type of enterprise user who is currently utilizing the enterprise application; (2) detecting (in real-time or near real-time) the point in time at which the enterprise user's current productive state with respect to the enterprise application includes a productive value is lower than a threshold productive value; and (3) determining (in real-time or near real-time) one or more suitable resources that are likely to increase the productive value of the enterprise user's current productive state to above the threshold productive value, as well as delivering such resource(s) to the enterprise user in real-time or near real-time (e.g., via the surfacing of such resource(s) on a user interface (UI) provided by the enterprise application).

In various embodiments, the real-time, context-aware resource delivery system described herein is utilized in conjunction with, or integrated into, one or more application suites or platforms that are utilized by the enterprise corresponding to the enterprise user, allowing the system functionalities to be delivered via any number of different enterprise applications that are supported by the platform. Notably, as used herein, the term “enterprise application” refers to any suitable types of web-based applications, mobile applications, and/or other applications/services that are provided by an application service provider. In general, the term “enterprise application” is used herein with reference to an application that forms part of a suite or package of products/services (or some subset of such suite/package) that is provided by the application service provider to enable users who are associated with an enterprise to interact with their corresponding computing systems to perform tasks relating to the enterprise. As a non-limiting example, if the application service provider is Microsoft Corporation, the enterprise applications described herein may include (but are not limited to) Microsoft® Viva®, Microsoft® Excel®, Microsoft® Word®, Microsoft® Teams®, Microsoft® PowerPoint®, Microsoft® Outlook®, Microsoft® OneNote®, Microsoft® OneDrive®, Microsoft® SharePoint®, Microsoft® Yammer® (among others), and/or any other applications that are included with the suite of Microsoft® 365® applications, for example. More generalized examples of suitable enterprise applications include (but are not limited to) email/communication applications, social networking applications, employee experience applications, calendar applications, and the like. In other words, the techniques described herein may be implemented within the context of a broad range of web-based applications, mobile applications, and/or additional applications/services that are utilized for enterprise-related tasks.

Moreover, it should be noted that the term “enterprise application” is used broadly herein to refer, not only to the enterprise application itself, but in some embodiments also more specifically to a particular functionality, tool, feature, product, or service offered by the enterprise application. One non-limiting example includes Viva® Goals provided by Microsoft® Viva® or, in some cases, even more specifically to the Objectives and Key Results (OKR) functionality provided by Viva® Goals. Other non-limiting examples include the equation function provided by Microsoft® Excel®, the user search function provided by Microsoft® Yammer®, the meeting scheduling tool provided by Microsoft® Teams®, and/or the presentation creation functionality provided by Microsoft® PowerPoint®. Moreover, those skilled in the art will appreciate that the types of functionalities, tools, features, products, and/or services that may be offered by enterprise application are quite vast and will continue to expand as enterprise applications evolve in the future.

Furthermore, the data that are utilized for performing the techniques described herein are referred to as “enterprise-level data,” meaning that such data are generally derived from users' interactions at the enterprise level (e.g., work- and/or career-related communications, tasks, and the like). However, in some cases, some amount of personal data may also be utilized, depending on the details of the particular implementation and the enterprise users' specific account settings. Moreover, in various embodiments, at least a portion of the enterprise-level data that are utilized for performing the techniques described herein are derived from one or more property graphs. In various embodiments, such property graph(s) include enterprise-level data that are maintained by the application service provider. Such enterprise-level data may include data objects (and metadata) relating to various types of enterprise resources, such as, for example, data objects relating to users, teams, chats, tasks, insights, coworkers, groups, calendars, files, messages, meetings, people, devices, learning resources, roles, projects, clients, and/or positions corresponding to the particular enterprise. In addition, in various embodiments, the property graph(s) include enterprise-level data that are provided by the enterprise itself. Such enterprise-level data may include data objects (and metadata) relating to logos, strings, links, structural/organizational information (e.g., information regarding administrators, employees, job titles, departments, and the like), and/or other types of enterprise resources that are maintained by the enterprise (e.g., in the enterprise's own database(s)). Moreover, in various embodiments, the enterprise-level data stored within the property graph also include telemetry data that are owned and maintained by the application service provider. Such telemetry data may include, for example, keystroke data, mouse click data, search query data, and the like, that are collected during enterprise users' interactions with the enterprise application(s). Furthermore, according to embodiments described herein, the enterprise-level data derived from the property graph(s) are used to drive and/or enhance the functionalities provided by the real-time, context-aware resource delivery system described herein, enabling such functionalities to be tailored to the goals and/or standards of the particular enterprise user and/or the associated enterprise.

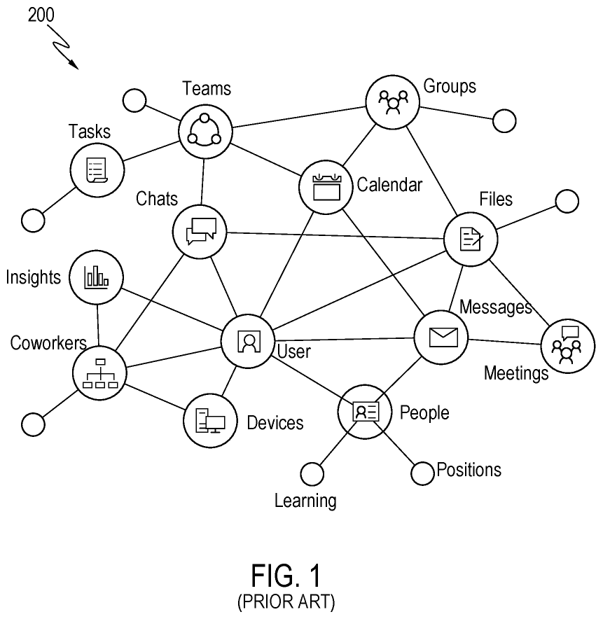

One non-limiting example of a suitable property graph that may be utilized according to embodiments described herein is Microsoft® Graph, which is provided by Microsoft Corporation. FIG. 1 is a simplified schematic view of Microsoft® Graph 100. As shown in FIG. 1, Microsoft® Graph 100 is a large property graph that includes the data underlying various Microsoft® applications and services, including (but not limited to) the suite of Microsoft 365® applications. Such applications include Microsoft® Viva®, Microsoft® Excel®, Microsoft® Word®, Microsoft® Teams®, Microsoft® PowerPoint®, Microsoft® Outlook®, Microsoft® OneNote®, Microsoft® OneDrive®, Microsoft® SharePoint®, and Microsoft® Yammer® (among others). Microsoft® Graph 100 also includes data that forms the backbone of Microsoft's cloud computing platform, Microsoft® Azure®. Moreover, the data within Microsoft® Graph 100 may be accessed and utilized to build new applications and/or to expand existing applications. Such functionality is provided via a corresponding API, which is generally referred to as the Microsoft® Graph API and is currently accessible at graph.microsoft.com.

As shown in FIG. 1, Microsoft® Graph 100 includes data about various types of enterprise resources. Such data may include, for example, data objects relating to users, teams, chats, tasks, insights, coworkers, groups, calendars, files, messages, meetings, people, devices, learning, and positions. Such data may be viewed from the perspective of the corresponding enterprise (which is sometimes referred to as a “tenant” in this context) and/or from the perspective of a specific enterprise user associated with the corresponding enterprise.

Within Microsoft® Graph 100, such data objects are represented as nodes. The relationships and/or interactions between the data objects are then represented using edges that connect the nodes within the property graph. As a few non-limiting examples, edges in the property graph might indicate that a particular user modified a particular document, that a particular user is working on a specific task, that certain resources are popular with particular users, that a particular enterprise includes a specific organizational structure, and/or that a particular user is learning about a certain topic.

Furthermore, it should be noted that Microsoft® Graph 100 is not limited to data obtained from Microsoft® applications and services. Rather, techniques exist to enable third-party application providers to incorporate their own data into Microsoft® Graph 100. In some cases, this is achieved using an “owner+decorator” model, in which a given resource or entity in the property graph is mastered by one provider (e.g., Microsoft Corporation) and then “decorated” with additional data by other third-party application providers. However, regardless of the technique utilized to incorporate such third-party data, the resulting property graph includes a wide variety of data objects that span across a wide variety of providers.

As used herein, the term “productive state,” when used with respect to the execution of an enterprise application by an enterprise user, refers broadly to a current state of the enterprise user with respect to the enterprise application as measured via one or more metrics that define a desired usage pattern for the enterprise application, particularly with respect to the attributes of the particular enterprise user (e.g., including the relevant comparable group for the enterprise user). Broadly speaking, the desired usage pattern may represent an optimal state that is guided by the “wisdom of crowds” concept. As an example, taking other enterprise users from the same enterprise (or the same team, same geographic area, or the like) as the comparable group, the productive state of the enterprise user includes a productive value that defines the enterprise user's success in utilizing the enterprise application as compared to the other enterprise users from the same enterprise (or the same team, same geographic area, or the like).

To that end, the term “productive value” is used herein to refer to a measurable, defined value corresponding to an enterprise user's productive state. This productive value may be measured or defined in any suitable manner that is geared towards determining the enterprise user's success in utilizing the enterprise application. Non-limiting examples of measurable, defined metrics that may be used to determine the productive value of an enterprise user include the enterprise users' satisfaction with the enterprise application, the usage intensity for the enterprise application, the purchase data for the enterprise application, the depth of usage for the enterprise application, and/or the breadth of usage for the enterprise application. As an example, the enterprise user's satisfaction may be determined based on the amount of positive feedback provided. The usage intensity may be determined based on whether the enterprise user continues to use the product (e.g., on a daily, weekly, or monthly basis, for example). The purchase data may be determined based on whether the enterprise user has an active subscription to the enterprise application. The depth of usage may be determined based on the number of features of the enterprise application that the enterprise user utilizes as compared to the total number of features offered by the enterprise application, which may be generally defined as a usage percentage (e.g., the enterprise user may utilize around 10% of the features offered by the enterprise application). The breadth of usage may be determined based on whether the enterprise user utilizes the enterprise application in conjunction with a larger productivity suite offered by the application service provider. Furthermore, other metrics may additionally or alternatively be utilized to define the productive value of an enterprise user's productive state, including, for example, metrics that are defined based on enterprise-level data corresponding to the enterprise user including, in particular, telemetry data corresponding to the enterprise user's keystrokes, mouse clicks, search query data, or the like, as described further herein.

The term “threshold productive value” is used herein to refer to a minimum acceptable productive value for an enterprise user's current productive state with respect to an enterprise application, which may be determined based on the productive states of other enterprise users from a comparable group (e.g., a particular enterprise, team, geographic area, or the like). In other words, the threshold productive value may be based, at least in part, on the “wisdom of crowds” concept and may therefore be determined based on the current productive value of other enterprise users from the relevant comparable group. Moreover, it should be noted that the threshold productive value may be incrementally increased over time to move all the enterprise users within a comparable group slowly toward an optimal productive state in which such users are realizing maximum value from the enterprise application.

According to embodiments described herein, the productive value of an enterprise user with respect to a particular enterprise application may be determined in any suitable manner depending on the metric(s) being considered. As an example, if the usage intensity is being considered, the productive value may be defined as the usage percentage of the enterprise user with respect to the enterprise application. As another example, if multiple metrics are being considered, the productive value may be defined as a composite score (e.g., a score of between 0 to 100) that represents how well the enterprise user satisfies each relevant metric with respect to the enterprise application. For example, this composite score may be calculated by quantifying each relevant metric, optionally with weightings that are based on the relative importance of each metric.

As a more specific example, in some embodiments, decision tree-based calculation techniques are utilized to determine the productive value of an enterprise user with respect to an enterprise application. For example, the decision tree may include a root node (at the top level) that defines a desired outcome for the user's interaction with the enterprise application (or the relevant feature or tool of the enterprise application), internal nodes (at the middle level) that define the purpose of each interaction, and leaf nodes (at the bottom level) corresponding to particular productive state attributes that define the enterprise user's current interaction with the enterprise application. Taking an OKR feature of an enterprise application as an example, the input to the decision tree may include data relating to the number of OKRs created by the user, the number of OKRs updated by the user, the number of OKRs viewed by the user, and the like, where such values define the user's current productive state attributes. By taking corresponding productive state attributes from other users within a comparable group into account according to the “wisdom of crowds” concept, the user's productive state attributes may be used to determine the user's current productive value at the leaf node level. Moving to the purpose node level, a determination may be made about whether the user's current productive value satisfies a current threshold productive value for the corresponding purpose, scenario, or use case being considered, as determined based on the current productive values of other users within the relevant comparable group. In this manner, once the root node is reached, it is possible to determine one or more resources that will likely achieve the desired outcome for the user's interaction with the enterprise application, as determined based on the values of the corresponding purpose and leaf nodes.

It is to be understood that the decision tree example described above is merely one exemplary implementation of the manner in which the productive state attributes, productive value, and threshold productive value may be determined according to the present techniques. In operation, any number of different calculation techniques may be utilized to determine such values. As an example, in some embodiments, Markov decision process (MDP) techniques may be utilized in place of (or in combination with) the decision tree techniques described above. Notably, in various embodiments, the calculation of such values is guided, at least in part, by machine learning techniques that take into account comparable data from large groups of enterprise users, optionally by utilizing a large amount of comparable enterprise-level data obtained from a property graph, as described herein.

Referring to the first aspect of the present techniques described above, in various embodiments, enterprise user attributes (including the type of enterprise user who is utilizing the enterprise application) are intelligently inferred based on user-related parameters and/or enterprise-related parameters. In various embodiments, such parameters are determined, at least in part, using enterprise-level data. Non-limiting examples of the types of parameters that may be utilized include one or more parameters relating to the enterprise user's current project with respect to the enterprise application, one or more parameters relating to the user's current role with respect to the enterprise application (e.g., administrator, champion, end user, or the like), one or more parameters relating to the enterprise user's current role with respect to the enterprise itself (e.g., manager, team leader, regular employee, or the like), one or more parameters relating to any team or internal organization to which the user is assigned, and/or one or more parameters relating to the enterprise's past interaction with the enterprise application (e.g., whether the enterprise user is the first, second, or subsequent enterprise user from the particular enterprise who has utilized the enterprise application or the relevant tool or functionality of the enterprise application). Moreover, as described above, at least a portion of such parameters are extracted from enterprise-level data derived from one or more property graphs that are maintained by the application service provider for the enterprise application.

In some embodiments, the parameter(s) relating to the enterprise user's current role with respect to the enterprise application are determined in a context-aware manner based on the execution of the enterprise application by the enterprise user and any other enterprise users associated with the enterprise. As an example, if the enterprise user who is attempting to utilize the enterprise application is the first user from the enterprise and/or the first user from their particular team within the enterprise, for example, to attempt to utilize such enterprise application, the resource delivery system described herein may flag the enterprise user as a champion of the enterprise application with respect to the enterprise. As another example, if the enterprise user is currently utilizing an administrator tool within the enterprise application, the resource delivery system may flag the user as an administrator of the enterprise application. In most other situations, the resource delivery system may simply flag the enterprise user as an end user with respect to the enterprise application.

Referring now to the second aspect of the present techniques, once the relevant enterprise user attributes have been determined, the enterprise's user's actions with respect to the enterprise application are monitored by the resource delivery system described herein in real-time or near real-time to automatically detect productive state attributes corresponding to a current productive state of the enterprise user with respect to the enterprise application. This may be iteratively performed until the resource delivery system detects that the productive value of the enterprise user's current productive state is below a predefined threshold productive value.

According to embodiments described herein, the productive state attributes are automatically detected in a context-aware manner based on the enterprise user's actions with respect to the enterprise application, where such actions may be determined based on enterprise-level data including, in particular, telemetry data corresponding to the user's keystrokes, mouse clicks, search query data, or the like. As non-limiting examples, the productive state attributes may account for data corresponding to the enterprise user's utilization of the enterprise application's “Help” feature, data corresponding to the enterprise user selecting the F1 key on the keyboard, data corresponding to an error message provided by the enterprise application, data corresponding to the enterprise user not progressing with respect to a particular task or workflow, data corresponding to the enterprise user unsuccessfully attempting to perform a particular task or workflow multiple times (or not finishing the task or workflow after a certain period of time), and/or data corresponding to the enterprise user opening a browser and searching for information regarding the enterprise application. Moreover, in various embodiments, the productive state attributes account for data that define whether (and to what degree) the enterprise user's current state with respect to the enterprise application deviates substantially from determined norms for the relevant comparable group (e.g., team, enterprise, geographic area, or the like).

Moreover, in various embodiments, the utilized enterprise-level data may account for various other metrics, such as, for example, enterprise users' satisfaction with the enterprise application, the usage intensity for the enterprise application, the purchase data for the enterprise application, the depth of usage for the enterprise application, and/or the breadth of usage for the enterprise application. As an example, the enterprise users' satisfaction may be determined based on the amount of positive feedback received. The usage intensity may be determined based on how many enterprise users continue to use the product (e.g., on a daily, weekly, or monthly basis, for example). The purchase data may be determined based on the number of subscriptions that remain active. The depth of usage may be determined based on the number of features of the enterprise application that the enterprise user utilizes as compared to the total number of features offered by the enterprise application. The breadth of usage may be determined based on the number of enterprise users who utilize the enterprise application in conjunction with a larger productivity suite offered by the application service provider.

Referring now to the third aspect of the present techniques, once the enterprise user attributes and the productive state attributes have been determined, the resource delivery system automatically determines one or more suitable resources that are likely to increase the productive value of the current productive state of the enterprise user to above the threshold productive value. According to embodiments described herein, this is accomplished via one or more propensity models that are maintained by the application service provider. Such propensity model(s) may be generated via a combination of machine learning techniques and heuristic techniques and may represent an intelligent, context-aware process for determining how to deliver value to enterprise users during the execution of the enterprise application, where the delivery of value may be judged based on, for example, the enterprise users' satisfaction with the enterprise application, the usage intensity for the enterprise application, the purchase data for the enterprise application, the depth of usage for the enterprise application, the breadth of usage for the enterprise application, and/or other similar metrics, as described above. Speaking more broadly, the propensity model(s) may provide information regarding the activities or sequences of activities (e.g. journeys) that lead to more enterprise users engaging with the enterprise application in a productive manner. In various embodiments, such propensity model(s) may include (at least in part) one or more machine learning models, such as one or more supervised and/or unsupervised machine learning models, that are generated (at least in part) using enterprise-level data obtained from one or more property graphs (e.g., including enterprise-level data that span across many different enterprises and many different tasks or scenarios). Moreover, such machine learning models may represent, for example, decision tree algorithms and/or random forest algorithms that are capable of predicting an enterprise user's next best action based on the enterprise user's current state.

According to embodiments described herein, such propensity model(s) are utilized, in combination with the enterprise user attributes and the productive state attributes, to determine one or more resources that are likely to increase the productive value of the current productive state of the enterprise user to above the threshold productive value. Such resources may include internal resources that are controlled by the application service provider, such as, for example, relevant automated resources (e.g., chat-bots and/or pop-ups that provide interactive guidance), media resources (e.g., documents or videos including product manuals, deployment guides, troubleshooting tips, or the like), and/or partner resources (e.g. consultants, staff, or sales support members that are pre-approved by the application service provider). Additionally or alternatively, such resources may include external resources that are not controlled by the application service provider, such as, for example, third party resources in the form of links to online forums, online videos, online articles, and/or products/services offered by third party entities that are geared toward providing relevant help for users.

Furthermore, in various embodiments, once the relevant resources have been identified using the propensity model(s), such resources are then delivered to the enterprise user in real-time or near real-time. In various embodiments, this is accomplished by surfacing such resources (or links to such resources) on the UI that is surfaced with respect to the enterprise application. According to embodiments described herein, the resources (or corresponding links) are provided within the context of the enterprise application (e.g., within the enterprise user's normal flow of work) without requiring the enterprise user to separately search for such resources. Accordingly, the present techniques serve to increase the overall productivity of the enterprise user and, thus, the corresponding enterprise.

In various embodiments, the resource delivery system described herein includes one or more integrated feedback mechanisms (or loops) that provide a means of evaluating the efficiency of the resource delivery process. Such feedback mechanism(s) may include one or more surveys, reviews, or the like that are completed from the perspective of the enterprise users and/or one or more partners who provide resources to enterprise users. Such feedback mechanism(s) may additionally or alternatively include one or more metrics regarding the percentage of usage or purchase, for example, of the enterprise application subsequent to the performance of the resource delivery process with respect to the enterprise application. Moreover, those skilled in the art will appreciate that any number of other suitable types of feedback mechanisms may additionally or alternatively be used to evaluate the efficiency of the process. Furthermore, in various embodiments, the system utilizes the obtained feedback to dynamically update the resource delivery process by, for example, updating the propensity model(s) that are utilized to perform the process.

The techniques described herein provides numerous advantages as compared to previous solutions. As an example, the present techniques provide for the real-time delivery of relevant resources in a context-aware manner (i.e., using enterprise-level data derived from a corresponding property graph) with very minimal intentional user input and without requiring the user to switch contexts by leaving the enterprise application and opening a browser to search for resources, thus saving users time and increasing the overall productivity for the corresponding enterprise. As another example, the present techniques provide for the automatic extraction of relevant parameters from enterprise-level data that are stored, at least in part, in a property graph that is maintained by the application service provider. This streamlines the resource delivery process and also ensures that the process is customized to the particular enterprise with which the enterprise user is associated. In addition, the utilization of such enterprise-level data also ensures that the resource delivery process is tailored to the particular enterprise user, since each user's work-related data are maintained in the property graph. As another example, the present techniques are implemented, at least in part, using machine learning techniques with built-in feedback mechanisms, thus ensuring that the resource delivery process can be continuously (or intermittently) updated to maintain relevancy in the quickly-evolving marketplace. As another example, the present techniques can be easily integrated into existing enterprise applications and application suites, allowing the resource delivery process described herein to be effortlessly incorporated into already-functioning enterprise environments. As another example, the resource delivery system provides a customized UI that enables enterprise users to quickly and efficiently utilize the surfaced resources.

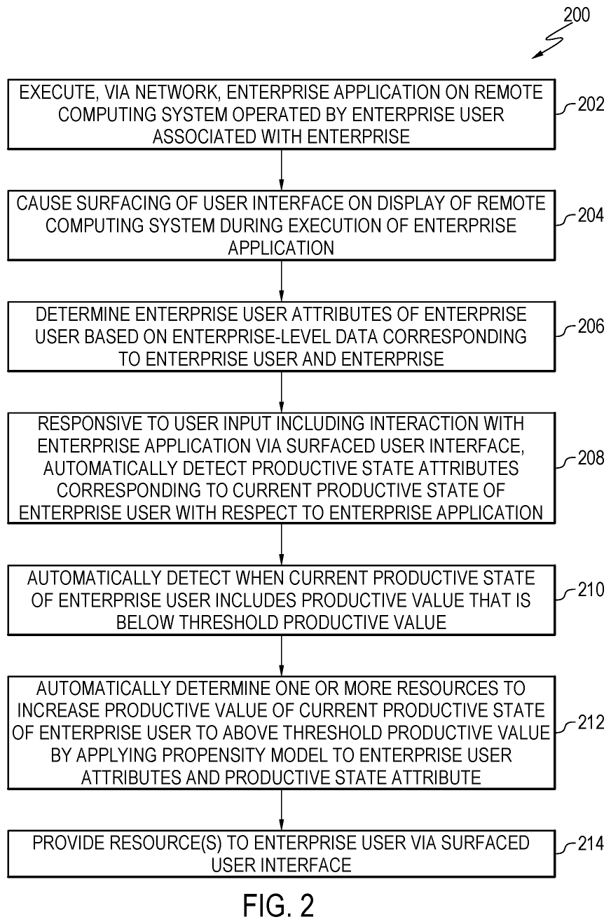

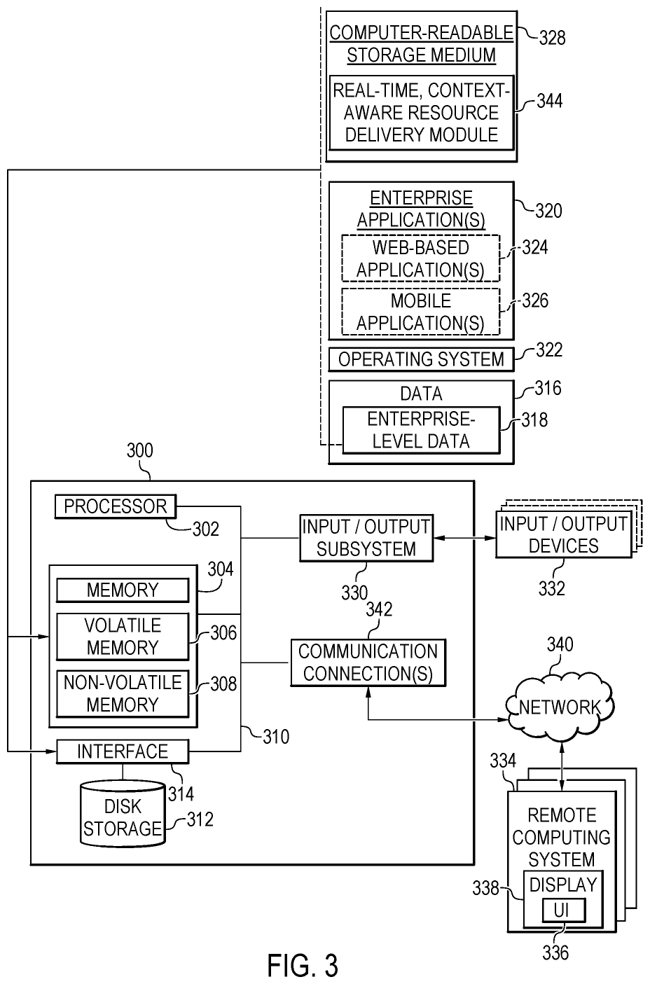

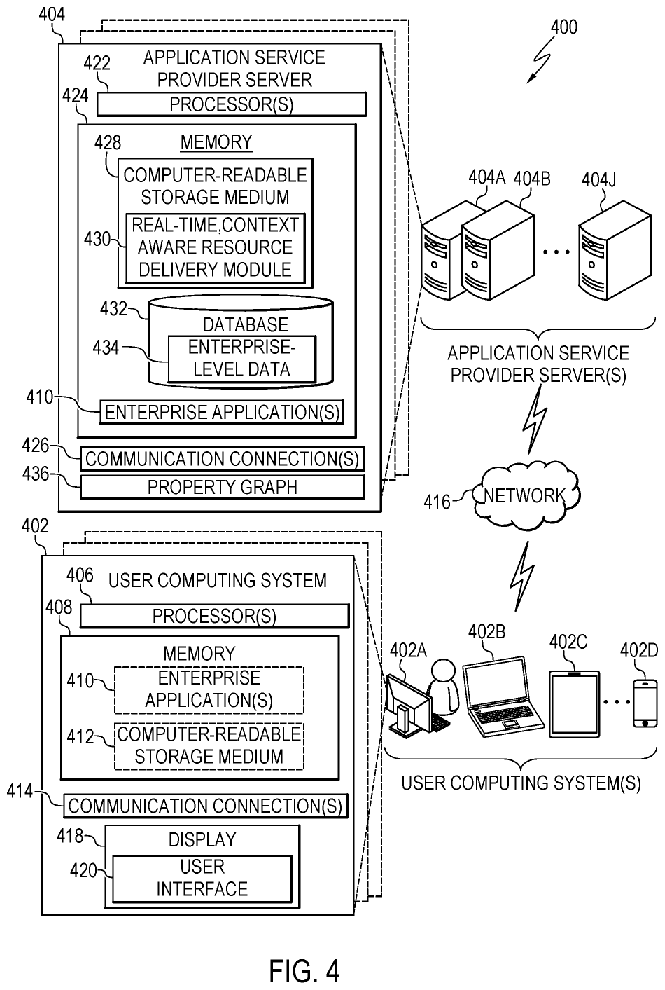

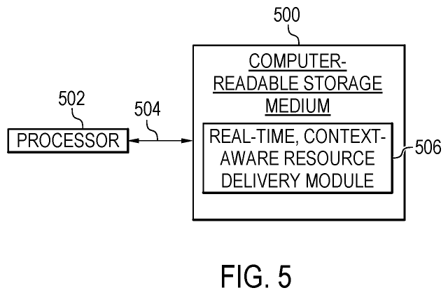

Turning now to additional details regarding the accompanying drawings, FIG. 2 is a process flow diagram of a method 200 for delivering relevant resources in real-time and in a context-aware manner during the execution of an enterprise application by an enterprise user according to embodiments described herein. The method 200 is executed via one or more computing systems, such as the exemplary computing system described with respect to FIG. 3. In particular, in various embodiments, the computing system(s) implementing the method 200 include computing system(s)/server(s) that are run by an application service provider who provides for the execution of an enterprise application (or a suite of enterprise applications) on remote computing systems associated with particular enterprises. The computing system(s) include one or more processors and one or more computer-readable storage media including computer-executable instructions that, when executed by the processor(s), cause the processor(s) to perform the blocks of the method 200. An exemplary embodiment of such computer-readable storage media is described with respect to FIG. 5. Moreover, in various embodiments, the method 200 is executed within the context of a network environment including one or more application service provider computing system(s)/server(s), as described further with respect to the exemplary network environment of FIG. 4.

The method 200 begins block 202, at which an enterprise application is executed, via the network, on a remote computing system operated by a user associated with an enterprise (referred to herein as an “enterprise user”). At block 204, a corresponding UI is caused to be surfaced on a display of the remote computing system during the execution of the enterprise application.

At block 206, enterprise user attributes of the enterprise user are determined based on enterprise-level data corresponding to the enterprise user and the enterprise. Such enterprise user attributes may include, for example, the type of enterprise user with respect to the enterprise application (e.g., administrator, champion, end user, or the like) and/or the type of enterprise user with respect to the enterprise itself (e.g., manager, team leader, regular employee, or the like). In various embodiments, such enterprise user attributes may be determined (at least in part) by extracting parameters associated with the enterprise user and the enterprise (e.g., role-based parameters, project-based parameters, and the like) from the enterprise-level data, extracting telemetry data associated with the enterprise user (e.g., keystroke data, mouse click data, search query data, and the like) from the enterprise-level data, and then determining the enterprise user attributes based on the extracted parameters and the extracted telemetry data.

At block 208, responsive to user input including an interaction with the enterprise application via the surfaced user interface, productive state attributes are automatically detected, where such productive state attributes correspond to a current productive state of the enterprise user with respect to the enterprise application. In various embodiments, this is accomplished (at least in part) by extracting telemetry data associated with the user input (e.g., keystroke data, mouse click data, search query data, and the like) from the enterprise-level data and then automatically detecting at least a portion of the productive state attributes based on the extracted telemetry data.

At block 210, it is automatically detected when the current productive state of the enterprise user includes a productive value that is below a predefined threshold productive value. At this point in time, the method proceeds to block 212, at which one or more resources that are likely to increase the productive value of the current productive state of the enterprise user to above the threshold productive value are automatically determined by applying a propensity model to the enterprise user attributes from block 206 and the productive state attributes from block 208. In various embodiments, the method 200 further includes (prior to executing block 212) generating the propensity model by applying one or more machine learning techniques and/or one or more heuristic techniques to enterprise-level data that span across multiple enterprises, as described herein.

At block 214, the identified resource(s) are provided to the enterprise user via the surfaced user interface. Such resource(s) may include, for example, one or more automated resources, one or more media resources, one or more partner resources, and/or one or more third party resources, as described herein. Moreover, in various embodiments, the resource(s) (or at least a portion of such resources) are provided to the enterprise user by surfacing one or more links to the resources on the user interface during the execution of the enterprise application (i.e., within the context of the enterprise application). Furthermore, those skilled in the art will appreciate that such resource(s) may additionally or alternatively be provided in any other suitable manner, depending on the details of the particular implementation. For example, the resource(s) may be provided by automatically surfacing one or more chat-bots and/or one or more pop-ups on the user interface and/or by surfacing one or more prompts on the user interface that direct the enterprise user to perform one or more actions to interact with the resource(s).

The block diagram of FIG. 2 is not intended to indicate that the blocks of the method 200 are to be executed in any particular order, or that all of the blocks of the method 200 are to be included in every case. Moreover, any number of additional blocks may be included within the method 200, depending on the details of the specific implementation. For example, in various embodiments, the method 200 also includes storing at least a portion of the enterprise-level data within a property graph that is maintained by the application service provider for the enterprise application and then accessing the enterprise-level data by searching the property graph (e.g., prior to executing block 206).

FIG. 3 is a block diagram of an exemplary computing system 300 for implementing the techniques described herein. The exemplary computing system 300 includes a processor 302 and a memory 304. The processor 302 may include any suitable type of processing unit or device, such as, for example, a single-core processor, a multi-core processor, a computing cluster, or any number of other configurations. Moreover, the processor 302 may include an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components, or any combinations thereof, designed to perform the functions described herein.

The memory 304 typically (but not always) includes both volatile memory 306 and non-volatile memory 308. The volatile memory 306 retains or stores information so long as the memory is supplied with power. By contrast, the non-volatile memory 308 is capable of storing (or persisting) information even when a power supply is not available. The volatile memory 306 may include, for example, RAM (e.g., synchronous RAM (SRAM), dynamic RAM (DRAM), synchronous dynamic RAM (SDRAM), and the like) and CPU cache memory. The nonvolatile memory 308 may include, for example, read-only memory (ROM) (e.g., programmable ROM (PROM), electrically programmable ROM (EPROM), electrically erasable ROM (EEROM) or the like), flash memory, nonvolatile random-access memory (RAM), solid-state memory devices, memory storage devices, and/or memory cards.

The processor 302 and the memory 304, as well as other components of the computing system 300, are interconnected by way of a system bus 310. The system bus 310 can be implemented using any suitable bus architecture known to those skilled in the art.

According to the embodiment shown in FIG. 3, the computing system 300 also includes a disk storage 312. The disk storage 312 may include any suitable removable/non-removable, volatile/non-volatile storage component or device. For example, the disk storage 312 may include, but is not limited to, a magnetic disk drive, floppy disk drive, tape drive, Jaz drive, Zip drive, LS-210 drive, flash memory card, memory stick, or the like. In addition, the disk storage 312 may include storage media separately from (or in combination with) other storage media including, but not limited to, an optical disk drive, such as a compact disk ROM device (CD-ROM), CD recordable drive (CD-R Drive), CD rewritable drive (CD-RW Drive) or a digital versatile disk ROM drive (DVD-ROM). To facilitate connection of the disk storage 312 to the system bus 310, a removable or non-removable interface is typically used, such as interface 314 shown in FIG. 3.

In various embodiments, the disk storage 312 and/or the memory 304 function as one or more databases that are used to store data 316 relating to the techniques described herein. Such data 316 may include, but are not limited to, enterprise-level data 318 (e.g., enterprise profile data, user profile data, device data, product data, usage data, telemetry data, and the like), which may be obtained, at least in part, from a property graph that is owned by an application service provider that provides one or more enterprise application(s) 320 (or a suite of such applications) according to embodiments described herein. In some embodiments, a portion of the enterprise-level data 318 may also be independently maintained by the enterprise and then uploaded during the resource delivery process described herein.

Those skilled in the art will appreciate that FIG. 3 describes software that acts as an intermediary between an enterprise user of the computing system 300 and the basic computing resources described with respect to the operating environment of the computing system 300. Such software includes an operating system 322. The operating system 322, which may be stored on the disk storage 312, acts to control and allocate the computing resources of the computing system 300. Moreover, the enterprise application(s) 318, including one or more web-based applications 324 and/or one or more mobile applications 326, take advantage of the management of the computing resources by the operating system 322 through one or more program modules stored within a computer-readable storage medium (or media) 328, as described further herein.

The computing system 300 also includes an input/output (I/O) subsystem 330. The I/O subsystem 330 includes a set of hardware, software, and/or firmware components that enable or facilitate inter-communication between the enterprise user of the computing system 300 and the processor 302 of the computing system 300. During operation of the computing system 300, the I/O subsystem 330 enables the enterprise user to interact with the computing system 300 through one or more I/O devices 332. Such I/O devices 332 may include any number of input devices or channels, such as, for example, one or more touchscreen/haptic input devices, one or more buttons, one or more pointing devices, one or more accessories, one or more audio input devices, and/or one or more video input devices, such as a camera. Furthermore, in some embodiments the one or more input devices or channels connect to the processor 302 through the system bus 310 via one or more interface ports (not shown) integrated within the I/O subsystem 330. Such interface ports may include, for example, a serial port, a parallel port, a game port, and/or a universal serial bus (USB).

In addition, such I/O devices 332 may include any number of output devices or channels, such as, for example, one or more audio output devices, one or more haptic feedback devices, and/or one or more displays. Such output devices or channels may use some of the same types of ports as the input devices or channels. Thus, for example, a USB port may be used to both provide input to the computing system 300 and to output information from the computing system 300 to a corresponding output device. Moreover, in some embodiments, the one or more output devices or channels are accessible via one or more adapters (not shown) integrated within the I/O subsystem 330.

In various embodiments, the computing system 300 is communicably coupled to any number of remote computing systems 334, such as remote computing systems that are operated by users (e.g., employees and/or employers) who are associated with an enterprise that utilizes (e.g., subscribes to) the enterprise application(s) 320. The remote computing system(s) 334 may include, for example, one or more personal computers, one or more servers, one or more routers, one or more network PCs, one or more workstations, one or more microprocessor-based appliances, one or more mobile phones, and/or one or more peer devices or other common network nodes. As an example, in various embodiments, the computing system 300 is an application service provider server hosting the enterprise application(s) 320 in a networked environment using logical connections to the remote computing systems 334. In such embodiments, the computing system 300 provides for the execution of the enterprise application(s) 320 on the remote computing systems 334 to provide an associated user interface (UI) 336 surfaced on a display 338 of each remote computing system 334, where each such UI 336 provides for the delivery of one or more relevant resources in real-time and in a context-aware manner during the execution of one of the enterprise applications 320 by a corresponding enterprise user, as described herein.

In various embodiments, the remote computing systems 334 are logically connected to the computing system 300 through a network 340 and then connected via a communication connection 342, which may be wireless. The network 340 encompasses wireless communication networks, such as local-area networks (LAN) and wide-area networks (WAN). LAN technologies include Fiber Distributed Data Interface (FDDI), Copper Distributed Data Interface (CDDI), Ethernet, Token Ring, and the like. WAN technologies include, but are not limited to, point-to-point links, circuit switching networks like Integrated Services Digital Networks (ISDN) and variations thereon, packet switching networks, and Digital Subscriber Lines (DSL).

The communication connection 342 includes the hardware/software employed to connect the network 340 to the bus 310. While the communication connection 342 is shown for illustrative clarity as residing inside the computing system 300, it can also be external to the computing system 300. The hardware/software for connection to the network 340 may include, for example, internal and external technologies, such as mobile phone switches, modems including regular telephone grade modems, cable modems and DSL modems, ISDN adapters, and/or Ethernet cards.

As described above, system applications, including the enterprise application(s) 320, take advantage of the management of the computing resources by the operating system 322 through one or more program modules stored within the computer-readable storage medium (or media) 328. In some embodiments, the computer-readable storage medium 328 is integral to the computing system 300, in which case it may form part of the memory 304 and/or the disk storage 312. In other embodiments, the computer-readable storage medium 328 is an external device that is connected to the computing system 300 when in use.

In various embodiments, the one or more program modules stored within the computer-readable storage medium 328 include program instructions or code that may be executed by the processor 302 to perform various operations. In various embodiments, such program modules include, but are not limited to, a real-time, context-aware resource delivery module 344 that causes the processor 302 to perform operations that result in the execution of the techniques provided herein, as described with respect to the method 200 of FIG. 2, for example.

It is to be understood that the block diagram of FIG. 3 is not intended to indicate that the computing system 300 is to include all of the components shown in FIG. 3. Rather, the computing system 300 can include fewer or additional components not illustrated in FIG. 3 (e.g., additional applications, additional modules, additional memory devices, additional network interfaces, etc.). Furthermore, any of the functionalities of the program module(s) may be partially, or entirely, implemented in hardware and/or in the processor 302. For example, the functionality may be implemented with an application specific integrated circuit, in logic implemented in the processor 302, or in any other device.

FIG. 4 is a block diagram of an exemplary network environment 400 for implementing the techniques described herein. As shown in FIG. 4, the network environment 400 includes one or more user computing systems 402 and one or more application service provider servers 404. Each user computing system 402 includes one or more processors 406 and memory 408 communicably coupled to the processor(s) 406. Each user computing system 402 may be implemented as any type of computing system, including (but not limited to) a personal computer, a laptop computer, a tablet computer, a portable digital assistant (PDA), a mobile phone (e.g., a smart phone), an electronic book (e-book) reader, a game console, a set-top box (STB), a smart television (TV), a portable game player, a portable media player, and so forth. FIG. 4 shows representative user computing systems in the forms of a desktop computer 402A, a laptop computer 402B, a tablet 402C, and a mobile device 402D. However, these are merely examples, and the user computing system(s) 402 described herein may take many other forms.

Each user computing system 402 may optionally include one or more enterprise applications 410 (or data corresponding to the execution of such enterprise application(s)) and one or more computer-readable storage media 412 stored in the memory 408, as described with respect to the computing system 300 of FIG. 3, for example. Each user computing system 402 also includes a communication connection 414 by which the user computing system 402 is able to communicate with other devices, including the application service provider server(s) 404, over a network 416. Furthermore, each user computing system 402 includes a display 418, which may be a built-in display or an external display, depending on the particular type of computing system. According to embodiments described herein, the display 418 is configured to surface a corresponding user interface (UI) 420 during the implementation of the techniques described herein.

The enterprise application(s) 410 and the corresponding resource delivery techniques described herein may be implemented or hosted by the application service provider server(s) 404, which may be provided as one or more server farms or data centers, for example. As an example, in the embodiment shown in FIG. 4, the application service provider server 404 includes multiple servers 404A-J, for example. Moreover, it should be noted that the server components shown in FIG. 4 may each be implemented within any or all of the multiple application service provider servers 404, depending on the details of the particular implementation. Specifically, the application service provider server(s) 404 include one or more processors 422 communicably coupled to memory 424. The memory 424 may include one or more multiple memory devices, depending on the details of the particular implementation. The application service provider server(s) 404 also include one or more communication connections 426 by which the enterprise application(s) 410 described herein may be executed or hosted on the user computing system(s) 402 via the network 416. In particular, the application service provider server(s) 404 provide for the execution of the enterprise application(s) 410 on the user computing system(s) 402 by, for example, surfacing one or more Uls associated with the enterprise application(s) 410 (including the UI 420) on the display 418 corresponding to each user computing system 402.

The memory 424 includes the enterprise application(s) 410 described herein, as well as one or more computer-readable storage media 428. The computer-readable storage medium (or media) 428 includes the real-time, context-aware resource delivery module 430 described herein (as some portion thereof), which includes computer-executable instructions that cause the processor(s) 422 and/or the processor(s) 406 to implement the techniques described herein. The memory 424 further includes a database 432, which may be configured to store (among other data) the enterprise-level data 434 described herein (or some portion thereof). As described herein, the enterprise-level data 434 (or some portion thereof) may be derived from a property graph 436 that is maintained by the application service provider. Moreover, while the property graph 436 is depicted as being stored within the same memory 424 as the enterprise application(s) 410, in some embodiments, such property graph 436 is maintained in one or more independent application service provider servers, and the application service provider servers executing the enterprise application(s) then interface with the property graph via a corresponding application programming interface (API).

It is to be understood that the simplified block diagram of FIG. 4 is not intended to indicate that the network environment 400 is to include all of the components shown in FIG. 4. Rather, the network environment 400 may include different components and/or additional components not illustrated in FIG. 4. For example, in practice, the server(s) 402 will include a number of additional components not depicted in the simplified block diagram of FIG. 4, as described with respect to the computing system 300 of FIG. 3, for example.

FIG. 5 is a block diagram of an exemplary computer-readable storage medium (or media) 500 for implementing the techniques described herein. In various embodiments, the computer-readable storage medium 500 is accessed by a processor 502 over a computer interconnect (or system bus) 504. For example, in some embodiments, the computer-readable storage medium 500 is the same as, or similar to, the computer-readable storage medium (or media) described with respect to the computing system 300 of FIG. 3 and/or the network environment 400 of FIG. 4.

In various embodiments, the computer-readable storage medium 500 includes code that directs the processor 502 to perform the operations of the present techniques. Such code may be stored within the computer-readable storage medium 500 in the form of program modules, where each program module includes a set of computer-executable instructions that, when executed by the processor 502, cause the processor 502 to perform a corresponding set of operations. In particular, in various embodiments, the computer-readable storage medium 500 includes a real-time, context-aware resource delivery module 506 that directs the processor 502 to perform the techniques described herein, such as, for example, the method 200 described with respect to FIG. 2 (or some suitable variation thereof).

Moreover, those skilled in the art will appreciate that any suitable number of the modules/sub-modules shown in FIG. 5 may be included within the computer-readable storage medium 500. Furthermore, any number of additional modules/sub-modules not shown in FIG. 5 may be included within the computer-readable storage medium 500, depending on the details of the specific implementation.

The following is a description of several exemplary implementations of the techniques described herein for particular use-case scenarios. Those skilled in the art will appreciate that these exemplary implementations are for illustrative purposes only. In practice, the techniques described herein may be implemented in any other suitable manner, depending on the details of the particular implementation.

In a first exemplary implementation, an enterprise user is attempting to set up OKRs for their enterprise within the Viva® Goals functionality of Microsoft® Viva®. However, the enterprise user is not knowledgeable about OKRs. The enterprise user is attempting to create an OKR through the corresponding UI but is not progressing as expected. Simultaneously, the resource delivery system detects that the enterprise user is the first user from their enterprise to attempt to utilize Viva® Goals functionality and, thus, flags the enterprise user as a champion of such functionality. The system further automatically detects the current productive state of the enterprise user and, after a certain period of time has elapsed, automatically detects that the enterprise user's current productive state is below a predefined threshold productive state, e.g., as evidenced by the fact that the enterprise user is not progressing as expected. Therefore, the system automatically determines one or more resources that are likely to increase the productive value of the current productive state of the enterprise user to above the threshold productive value. The system then delivers such resource(s) to the enterprise user in real-time (or near real-time) within the context of the Viva® Goals functionality (i.e., as part of the UI corresponding to such functionality). As an example, the system may automatically surface a chat-bot, pop-up, or prompt to allow the enterprise user to learn more about OKRs. As another example, the system may automatically surface a link to an online video or online article regarding OKR creation. As another example, the system may automatically surface a link or prompt that enables the enterprise user to connect with one or more partners of the application service provider, where such partners are equipped to aid the user in learning about OKRs.

In a second exemplary implementation (and continuing with the above example), the enterprise user has successfully created OKRs through Viva® Goals but is waiting for their leadership and/or team members to review and/or approve such OKRs. The system automatically detects the current productive state of the enterprise user and, after a certain period of time has elapsed, automatically detects that the enterprise user's current productive state is below a predefined threshold productive state, e.g., as evidenced by the fact that their leadership and/or team members have not responded to the OKR review/approval request in a timely manner. As a result, the system automatically determines one or more resources that will increase the productive value of the current productive state of the enterprise user to above the threshold productive value, e.g., by aiding the enterprise user with moving the process forward, and then automatically provides such resource(s) in real-time (or near real-time). As an example, the system may surface links to offerings from change management partners that are likely to help the enterprise user to move the process forward. As another example, if the system detects that the enterprise user has created an excessively large number of OKRs, the system may surface links to internal and/or external content (e.g., documents, videos, or the like) regarding OKR best practices.

As a general matter, some components shown in the figures are described herein in the context of one or more structural components, referred to as functionalities, modules, features, elements, etc. However, the components shown in the figures can be implemented in any manner, for example, by software, hardware (e.g., discrete logic components, etc.), firmware, and so on, or any combination of these implementations. In one embodiment, the various components may reflect the use of corresponding components in an actual implementation. In other embodiments, any single component illustrated in the figures may be implemented by a number of actual components. The depiction of any two or more separate components in the figures may reflect different functions performed by a single actual component.

Other figures describe the concepts in flowchart form. In this form, certain operations are described as constituting distinct blocks performed in a certain order. Such implementations are exemplary and non-limiting. Certain blocks described herein can be grouped together and performed in a single operation, certain blocks can be broken apart into plural component blocks, and certain blocks can be performed in an order that differs from that which is illustrated herein, including a parallel manner of performing the blocks. The blocks shown in the flowcharts can be implemented by software, hardware, firmware, and the like, or any combination of these implementations. As used herein, hardware may include computing systems, discrete logic components, such as application specific integrated circuits (ASICs), and the like, as well as any combinations thereof.

As for terminology, the phrase “configured to” encompasses any way that any kind of structural component can be constructed to perform an identified operation. The structural component can be configured to perform an operation using software, hardware, firmware and the like, or any combinations thereof. For example, the phrase “configured to” can refer to a logic circuit structure of a hardware element that is to implement the associated functionality. The phrase “configured to” can also refer to a logic circuit structure of a hardware element that is to implement the coding design of associated functionality of firmware or software. The term “module” refers to a structural element that can be implemented using any suitable hardware (e.g., a processor, among others), software (e.g., an application, among others), firmware, or any combination of hardware, software, and firmware.

The term “logic” encompasses any functionality for performing a task. For instance, each operation illustrated in the flowcharts corresponds to logic for performing that operation. An operation can be performed using software, hardware, firmware, etc., or any combinations thereof.

As utilized herein, the terms “component”, “system”, and the like are intended to refer to a computer-related entity, either hardware, software (e.g., in execution), and/or firmware, or a combination thereof. For example, a component can be a process running on a processor, an object, an executable, a program, a function, a library, a subroutine, and/or a computer or a combination of software and hardware. By way of illustration, both an application running on a server and the server can be a component. One or more components can reside within a process and a component can be localized on one computer and/or distributed between two or more computers.

Furthermore, the claimed subject matter may be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any tangible computer-readable storage medium.

Moreover, as used herein, the term “computer-readable storage medium” refers to an article of manufacture. In general, computer-readable storage media are used to host, store and/or reproduce computer-executable instructions and data for later retrieval and/or execution. When the computer-executable instructions that are hosted or stored on the computer-readable storage media are executed by a processor of a computing system, the execution thereof causes, configures and/or adapts the executing computing system to carry out various steps, processes, routines, methods and/or functionalities, including the steps, processes, routines, methods, and/or functionalities described herein. Examples of computer-readable storage media include, but are not limited to, optical storage media (such as Blu-ray discs, digital video discs (DVDs), compact discs (CDs), optical disc cartridges, and the like), magnetic storage media (such as hard disk drives, floppy disks, magnetic tape, and the like), memory storage devices (such as random access memory (RAM), read-only memory (ROM), memory cards, thumb drives, and the like), and cloud storage (such as online storage services). Computer-readable storage media may deliver computer-executable instructions to a computing system for execution via various transmission means and mediums, including carrier waves and/or propagated signals. However, for purposes of this disclosure, the term “computer-readable storage medium (or media)” refers specifically to non-transitory forms of computer-readable storage media and expressly excludes carrier waves and/or propagated signals.

The singular forms “a”, “an”, and “the”, as used herein, mean one or more when applied to any embodiment described herein. In other words, the use of “a”, “an”, and/or “the” does not limit the meaning to a single feature unless such a limit is specifically stated. Moreover, the term “any” may refer to one, some, or all of a specified entity, if any of the specified entity exists or is present.

The term “and/or” placed between a first entity and a second entity means one of (1) the first entity, (2) the second entity, and (3) the first entity and the second entity. Multiple entities listed with “and/or” should be construed in the same manner, i.e., “one or more” of the entities so conjoined. Other entities may optionally be present other than the entities specifically identified by the “and/or” clause, whether related or unrelated to those entities specifically identified. Thus, as a non-limiting example, a reference to “A and/or B”, when used in conjunction with open-ended language such as “including”, may refer, in one embodiment, to A only (optionally including entities other than B); in another embodiment, to B only (optionally including entities other than A); in yet another embodiment, to both A and B (optionally including other entities).

The phrase “at least one”, when used in reference to a list of one or more entities, should be understood to mean at least one entity selected from any one or more of the entities in the list of entities, but not necessarily including at least one of each and every entity specifically listed within the list of entities, and not excluding any combinations of entities in the list of entities. This definition also allows that entities may optionally be present other than the entities specifically identified within the list of entities to which the phrase “at least one” refers, whether related or unrelated to those entities specifically identified. Thus, as a non-limiting example, “at least one of A or B” (or, equivalently, “at least one of A and B”) may refer, in one embodiment, to at least one, optionally including more than one, A, with no B present (and optionally including entities other than B); in another embodiment, to at least one, optionally including more than one, B, with no A present (and optionally including entities other than A); in yet another embodiment, to at least one, optionally including more than one, A, and at least one, optionally including more than one, B (and optionally including other entities). In other words, the phrases “at least one”, “one or more”, and “and/or” are open-ended expressions that are both conjunctive and disjunctive in operation.

The phrase “based on” should not be construed to mean “based only on”, unless expressly specified otherwise. In other words, the phrase “based on” means “based only on”, “based at least on”, and/or “based at least in part on”.

The present techniques may be susceptible to various modifications and alternative forms, including (but not limited to) those described in the following examples:

Example 1 is a method for delivering relevant resources during the execution of an enterprise application by an enterprise user, where the method is implemented via a computing system including a processor, and where the method includes: (a) executing, via a network, an enterprise application on a remote computing system operated by an enterprise user associated with an enterprise; (b) causing surfacing of a user interface on a display of the remote computing system during the execution of the enterprise application; (c) determining enterprise user attributes of the enterprise user based on enterprise-level data corresponding to the enterprise user and the enterprise; (d) responsive to user input including an interaction with the enterprise application via the surfaced user interface, automatically detecting productive state attributes corresponding to a current productive state of the enterprise user with respect to the enterprise application; (e) automatically detecting when the current productive state of the enterprise user includes a productive value that is below a threshold productive value; (f) automatically determining a resource to increase the productive value of the current productive state of the enterprise user to above the threshold productive value by applying a propensity model to the enterprise user attributes and the productive issue attributes; and (g) providing the resource to the enterprise user via the surfaced user interface.

Example 2 includes the method of example 1, including or excluding optional features. In this example, the method includes storing at least a portion of the enterprise-level data within a property graph; and accessing the enterprise-level data by searching the property graph.

Example 3 includes the method of example 1 or 2, including or excluding optional features. In this example, the method includes determining the enterprise user attributes of the enterprise user based on the enterprise-level data by: extracting parameters associated with the enterprise user and the enterprise from the enterprise-level data; extracting telemetry data associated with the enterprise user from the enterprise-level data; and determining the enterprise user attributes based on the extracted parameters and the extracted telemetry data.

Example 4 includes the method of any one of examples 1 to 3, including or excluding optional features. In this example, the method includes automatically detecting the productive state attributes by: extracting telemetry data associated with the user input from the enterprise-level data; and automatically detecting at least a portion of the productive state attributes based on the extracted telemetry data.

Example 5 includes the method of any one of examples 1 to 4, including or excluding optional features. In this example, the method includes providing the resource to the enterprise user by surfacing a link to the resource on the user interface during the execution of the enterprise application.

Example 6 includes the method of any one of examples 1 to 5, including or excluding optional features. In this example, the method is performed in real-time or near real-time.

Example 7 includes the method of any one of examples 1 to 6, including or excluding optional features. In this example, the method includes generating the propensity model by applying at least one of a machine learning technique or a heuristic technique to enterprise-level data that span across multiple enterprises.

Example 8 includes the method of any one of examples 1 to 7, including or excluding optional features. In this example, the resource includes at least one of an automated resource, a media resource, a partner resource, or a third party resource.

Example 9 is a computer-readable storage medium. The computer-readable storage medium includes computer-executable instructions that, when executed by a processor, cause the processor to: (a) execute an enterprise application on a computing system operated by an enterprise user associated with an enterprise; (b) cause surfacing of a user interface on a display of the computing system during the execution of the enterprise application; (c) determine enterprise user attributes of the enterprise user based on enterprise-level data corresponding to the enterprise user and the enterprise; (d) responsive to user input including an interaction with the enterprise application via the surfaced user interface, automatically detect productive state attributes corresponding to a current productive state of the enterprise user with respect to the enterprise application; (e) automatically detect when the current productive state of the enterprise user includes a productive value that is below a threshold productive value; (f) automatically determine a resource to increase the productive value of the current productive state of the enterprise user to above the threshold productive value by applying a propensity model to the enterprise user attributes and the productive issue attributes; and (g) provide the resource to the enterprise user via the surfaced user interface.

Example 10 includes the computer-readable storage medium of example 9, including or excluding optional features. In this example, the computer-executable instructions, when executed by the processor, cause the processor to: store at least a portion of the enterprise-level data within a property graph; and access the enterprise-level data by searching the property graph.

Example 11 includes the computer-readable storage medium of example 9 or 10, including or excluding optional features. In this example, the computer-executable instructions, when executed by the processor, cause the processor to determine the enterprise user attributes of the enterprise user based on the enterprise-level data by: extracting parameters associated with the enterprise user and the enterprise from the enterprise-level data; extracting telemetry data associated with the enterprise user from the enterprise-level data; and determining the enterprise user attributes based on the extracted parameters and the extracted telemetry data.

Example 12 includes the computer-readable storage medium of any one of examples 9 to 11, including or excluding optional features. In this example, the computer-executable instructions, when executed by a processor, cause the processor to automatically detect the productive state attributes by: extracting telemetry data associated with the user input from the enterprise-level data; and automatically detecting at least a portion of the productive state attributes based on the extracted telemetry data.

Example 13 includes the computer-readable storage medium of any one of examples 9 to 12, including or excluding optional features. In this example, the computer-executable instructions, when executed by the processor, cause the processor to provide the resource to the enterprise user by surfacing a link to the resource on the user interface during the execution of the enterprise application.

Example 14 includes the computer-readable storage medium of any one of examples 9 to 13, including or excluding optional features. In this example, the computer-executable instructions, when executed by a processor, cause the processor to generate the propensity model by applying at least one of a machine learning technique or a heuristic technique to enterprise-level data that span across multiple enterprises.

Example 15 includes the computer-readable storage medium of any one of examples 9 to 14, including or excluding optional features. In this example, the resource includes at least one of an automated resource, a media resource, a partner resource, or a third party resource.

Example 16 is an application service provider server. The application service provider server includes: a processor; a memory, including an enterprise application that is utilized by an enterprise and a property graph including enterprise-level data corresponding to the enterprise and corresponding enterprise users; a communication connection for connecting a remote computing system to the application service provider server via a network, where the remote computing system is operated by an enterprise user associated with the enterprise; and a computer-readable storage medium operatively coupled to the processor, the computer-readable storage medium including computer-executable instructions that, when executed by the processor, cause the processor to: (a) execute, via the network, the enterprise application on the remote computing system; (b) cause surfacing of a user interface on a display of the remote computing system during the execution of the enterprise application; (c) extract enterprise-level data corresponding to the enterprise user and the enterprise from the property graph; (d) determine enterprise user attributes of the enterprise user based on the enterprise-level data; (e) responsive to user input including an interaction with the enterprise application via the surfaced user interface, automatically detect productive state attributes corresponding to a current productive state of the enterprise user with respect to the enterprise application; (f) automatically detect when the current productive state of the enterprise user includes a productive value that is below a threshold productive value; (g) automatically determine a resource to increase the productive value of the current productive state of the enterprise user to above the threshold productive value by applying a propensity model to the enterprise user attributes and the productive issue attributes; and (h) provide the resource in real-time or near real-time via the surfaced user interface.

Example 17 includes the application service provider server of example 16, including or excluding optional features. In this example, the computer-readable storage medium includes computer-executable instructions that, when executed by the processor, cause the processor to determine the enterprise user attributes of the enterprise user based on the enterprise-level data by: extracting parameters associated with the enterprise user and the enterprise from the enterprise-level data; extracting telemetry data associated with the enterprise user from the enterprise-level data; and determining the enterprise user attributes based on the extracted parameters and the extracted telemetry data.

Example 18 includes the application service provider server of example 16 or 17, including or excluding optional features. In this example, the computer-readable storage medium includes computer-executable instructions that, when executed by the processor, cause the processor to automatically detect the productive state attributes by: extracting telemetry data associated with the user input from the enterprise-level data; and automatically detecting at least a portion of the productive state attributes based on the extracted telemetry data.

Example 19 includes the application service provider server of any one of examples 16 to 18, including or excluding optional features. In this example, the computer-readable storage medium includes computer-executable instructions that, when executed by the processor, cause the processor to provide the resource by surfacing a link to the resource on the user interface during the execution of the enterprise application.

Example 20 includes the application service provider server of any one of examples 16 to 19, including or excluding optional features. In this example, the computer-readable storage medium includes computer-executable instructions that, when executed by the processor, cause the processor to generate the propensity model by applying at least one of a machine learning technique or a heuristic technique to enterprise-level data that span across multiple enterprises.

It should be noted that, while the methods and processes described herein are generally expressed in regard to discrete steps, these steps should be viewed as being logical in nature and may or may not correspond to any specific actual and/or discrete steps of a given implementation. In addition, the order in which these steps are presented in the various methods and processes, unless otherwise indicated, should not be construed as the only order in which the steps may be carried out. Moreover, in some instances, some of these steps may be combined and/or omitted. Those skilled in the art will recognize that the logical presentation of steps is sufficiently instructive to carry out aspects of the claimed subject matter irrespective of any particular development or coding language in which the logical instructions/steps are encoded.

Of course, while the methods and processes described herein include various novel features of the disclosed subject matter, other steps (not listed) may also be carried out in the execution of the subject matter set forth in these methods and processes. Those skilled in the art will appreciate that the logical steps of these methods and processes may be combined together or split into additional steps. Steps of the above-described methods and processes may be carried out in parallel or in series. Often, but not exclusively, the functionality of a particular method or process is embodied in software (e.g., applications, system services, libraries, and the like) that is executed on one or more processors of computing systems. Additionally, in various embodiments, all or some of the various methods and processes may also be embodied in executable hardware modules including, but not limited to, system on chips (SoC's), codecs, specially designed processors and/or logic circuits, and the like, on a computing system.

As suggested above, each method or process described herein is typically embodied within computer-executable instruction (or code) modules including individual routines, functions, looping structures, selectors, and switches (such as if-then and if-then-else statements), assignments, arithmetic computations, and the like, that, in execution, configure a computing system to operate in accordance with the particular method or process. However, as suggested above, the exact implementation in executable statement of each of the methods or processes is based on various implementation configurations and decisions, including programming languages, compilers, target processors, operating environments, and the linking or binding operation. Those skilled in the art will readily appreciate that the logical steps identified in these methods and processes may be implemented in any number of ways and, thus, the logical descriptions set forth above are sufficiently enabling to achieve similar results.

While various novel aspects of the disclosed subject matter have been described, it should be appreciated that these aspects are exemplary and should not be construed as limiting. Variations and alterations to the various aspects may be made without departing from the scope of the disclosed subject matter.

In particular and in regard to the various functions performed by the above described components, devices, circuits, systems and the like, the terms (including a reference to a “means”) used to describe such components are intended to correspond, unless otherwise indicated, to any component which performs the specified function of the described component, e.g., a functional equivalent, even though not structurally equivalent to the disclosed structure, which performs the function in the herein illustrated exemplary aspects of the claimed subject matter. In this regard, it will also be recognized that the innovation includes a system as well as a computer-readable storage media having computer-executable instructions for performing the acts and events of the various methods of the claimed subject matter.

There are multiple ways of implementing the claimed subject matter, e.g., an appropriate API, tool kit, driver code, operating system, control, standalone or downloadable software object, etc., which enables applications and services to use the techniques described herein. The claimed subject matter contemplates the use from the standpoint of an API (or other software object), as well as from a software or hardware object that operates according to the techniques set forth herein. Thus, various implementations of the claimed subject matter described herein may have aspects that are wholly in hardware, partly in hardware and partly in software, as well as in software.

The aforementioned systems have been described with respect to interactions between several components. It can be appreciated that such systems and components can include those components or specified sub-components, some of the specified components or sub-components, and additional components, and according to various permutations and combinations of the foregoing. Sub-components can also be implemented as components communicatively coupled to other components rather than included within parent components (hierarchical).

Additionally, it can be noted that one or more components may be combined into a single component providing aggregate functionality or divided into several separate sub-components, and any one or more middle layers, such as a management layer, may be provided to communicatively couple to such sub-components in order to provide integrated functionality. Any components described herein may also interact with one or more other components not specifically described herein but generally known by those of skill in the art.

In addition, while a particular feature of the claimed subject matter may have been disclosed with respect to one of several implementations, such feature may be combined with one or more other features of the other implementations as may be desired and advantageous for any given or particular application. Furthermore, to the extent that the terms “includes,” “including,” “has,” “contains,” variants thereof, and other similar words are used in either the detailed description or the claims, these terms are intended to be inclusive in a manner similar to the term “comprising” as an open transition word without precluding any additional or other elements.

What is claimed is:

1. A method for delivering relevant resources during the execution of an enterprise application by an enterprise user, wherein the method is implemented via a computing system comprising a processor, and wherein the method comprises:
executing, via a network, an enterprise application on a remote computing system operated by an enterprise user associated with an enterprise;
causing surfacing of a user interface on a display of the remote computing system during the execution of the enterprise application;
determining enterprise user attributes of the enterprise user based on enterprise-level data corresponding to the enterprise user and the enterprise;
responsive to user input comprising an interaction with the enterprise application via the surfaced user interface, automatically detecting productive state attributes corresponding to a current productive state of the enterprise user with respect to the enterprise application;
automatically detecting when the current productive state of the enterprise user comprises a productive value that is below a threshold productive value;
automatically determining a resource to increase the productive value of the current productive state of the enterprise user to above the threshold productive value by applying a propensity model to the enterprise user attributes and the productive state attributes; and
providing the resource to the enterprise user via the surfaced user interface.

2. The method of claim 1, comprising:
storing at least a portion of the enterprise-level data within a property graph; and
accessing the enterprise-level data by searching the property graph.

3. The method of claim 1, comprising determining the enterprise user attributes of the enterprise user based on the enterprise-level data by:
extracting parameters associated with the enterprise user and the enterprise from the enterprise-level data;
extracting telemetry data associated with the enterprise user from the enterprise-level data; and
determining the enterprise user attributes based on the extracted parameters and the extracted telemetry data.

4. The method of claim 1, comprising automatically detecting the productive state attributes by:
extracting telemetry data associated with the user input from the enterprise-level data; and
automatically detecting at least a portion of the productive state attributes based on the extracted telemetry data.

5. The method of claim 1, comprising providing the resource to the enterprise user by surfacing a link to the resource on the user interface during the execution of the enterprise application.

6. The method of claim 1, comprising performing the method in real-time or near real-time.

7. The method of claim 1, comprising generating the propensity model by applying at least one of a machine learning technique or a heuristic technique to enterprise-level data that span across multiple enterprises.

8. The method of claim 1, wherein the resource comprises at least one of an automated resource, a media resource, a partner resource, or a third party resource.

9. A computer-readable storage medium comprising computer-executable instructions that, when executed by a processor, cause the processor to:
execute an enterprise application on a computing system operated by an enterprise user associated with an enterprise;
cause surfacing of a user interface on a display of the computing system during the execution of the enterprise application;
determine enterprise user attributes of the enterprise user based on enterprise-level data corresponding to the enterprise user and the enterprise;
responsive to user input comprising an interaction with the enterprise application via the surfaced user interface, automatically detect productive state attributes corresponding to a current productive state of the enterprise user with respect to the enterprise application;
automatically detect when the current productive state of the enterprise user comprises a productive value that is below a threshold productive value;
automatically determine a resource to increase the productive value of the current productive state of the enterprise user to above the threshold productive value by applying a propensity model to the enterprise user attributes and the productive state attributes; and
provide the resource to the enterprise user via the surfaced user interface.

10. The computer-readable storage medium of claim 9, comprising computer-executable instructions that, when executed by the processor, cause the processor to:
store at least a portion of the enterprise-level data within a property graph; and
access the enterprise-level data by searching the property graph.

11. The computer-readable storage medium of claim 9, comprising computer-executable instructions that, when executed by the processor, cause the processor to determine the enterprise user attributes of the enterprise user based on the enterprise-level data by:
extracting parameters associated with the enterprise user and the enterprise from the enterprise-level data;
extracting telemetry data associated with the enterprise user from the enterprise-level data; and
determining the enterprise user attributes based on the extracted parameters and the extracted telemetry data.

12. The computer-readable storage medium of claim 9, comprising computer-executable instructions that, when executed by a processor, cause the processor to automatically detect the productive state attributes by:
extracting telemetry data associated with the user input from the enterprise-level data; and
automatically detecting at least a portion of the productive state attributes based on the extracted telemetry data.

13. The computer-readable storage medium of claim 9, comprising computer-executable instructions that, when executed by the processor, cause the processor to provide the resource to the enterprise user by surfacing a link to the resource on the user interface during the execution of the enterprise application.

14. The computer-readable storage medium of claim 9, comprising computer-executable instructions that, when executed by a processor, cause the processor to generate the propensity model by applying at least one of a machine learning technique or a heuristic technique to enterprise-level data that span across multiple enterprises.

15. The computer-readable storage medium of claim 9, wherein the resource comprises at least one of an automated resource, a media resource, a partner resource, or a third party resource.

16. An application service provider server, comprising:
a processor;
a memory, comprising:
an enterprise application that is utilized by an enterprise; and
a property graph comprising enterprise-level data corresponding to the enterprise and corresponding enterprise users;
a communication connection for connecting a remote computing system to the application service provider server via a network, wherein the remote computing system is operated by an enterprise user associated with the enterprise; and
a computer-readable storage medium operatively coupled to the processor, the computer-readable storage medium comprising computer-executable instructions that, when executed by the processor, cause the processor to:
execute, via the network, the enterprise application on the remote computing system;
cause surfacing of a user interface on a display of the remote computing system during the execution of the enterprise application;
extract enterprise-level data corresponding to the enterprise user and the enterprise from the property graph;
determine enterprise user attributes of the enterprise user based on the enterprise-level data;
responsive to user input comprising an interaction with the enterprise application via the surfaced user interface, automatically detect productive state attributes corresponding to a current productive state of the enterprise user with respect to the enterprise application;
automatically detect when the current productive state of the enterprise user comprises a productive value that is below a threshold productive value;
automatically determine a resource to increase the productive value of the current productive state of the enterprise user to above the threshold productive value by applying a propensity model to the enterprise user attributes and the productive state attributes; and
provide the resource in real-time or near real-time via the surfaced user interface.

17. The application service provider server of claim 16, wherein the computer-readable storage medium comprises computer-executable instructions that, when executed by the processor, cause the processor to determine the enterprise user attributes of the enterprise user based on the enterprise-level data by:
extracting parameters associated with the enterprise user and the enterprise from the enterprise-level data;
extracting telemetry data associated with the enterprise user from the enterprise-level data; and
determining the enterprise user attributes based on the extracted parameters and the extracted telemetry data.

18. The application service provider server of claim 16, wherein the computer-readable storage medium comprises computer-executable instructions that, when executed by the processor, cause the processor to automatically detect the productive state attributes by:
extracting telemetry data associated with the user input from the enterprise-level data; and
automatically detecting at least a portion of the productive state attributes based on the extracted telemetry data.

19. The application service provider server of claim 16, wherein the computer-readable storage medium comprises computer-executable instructions that, when executed by the processor, cause the processor to provide the resource by surfacing a link to the resource on the user interface during the execution of the enterprise application.

20. The application service provider server of claim 16, wherein the computer-readable storage medium comprises computer-executable instructions that, when executed by the processor, cause the processor to generate the propensity model by applying at least one of a machine learning technique or a heuristic technique to enterprise-level data that span across multiple enterprises.
